(19) United States
(12) Patent Application Publication
(10) Pub. No.: US 2009/0261595 A1
(43) Pub. Date: Oct. 22, 2009

(54) APPARATUS FOR GENERATING ELECTRIC POWER USING WIND ENERGY

(76) Inventor: Hao-Wei Poo, Taipei City (TW)

Correspondence Address: LADAS & PARRY, 5670 WILSHIRE BOULEVARD, SUITE 2100, LOS ANGELES, CA, 90036-5679, US

(21) Appl. No.: 12/104,629

(22) Filed: Apr. 17, 2008

(51) Int. Cl. F03D 9/00; F03D 7/00

(52) U.S. Cl. 290/55

(57) ABSTRACT

An apparatus for generating electric power from wind energy includes an upright structural frame having a base frame portion, an upright rod extending vertically along a pivot axis that passes through a center of the structural frame, and having a lower end disposed in the base frame portion of the structural frame. A blade unit is mounted fixedly on the upright rod such that an assembly of the upright rod and the blade unit is rotatable relative to the structural frame about the pivot axis so as to convert wind energy into a mechanical rotary power output. A generator is mounted on the base frame portion of the structural frame and is coupled to the lower end of the blade unit to convert the mechanical rotary power output into electric power.

### BACKGROUND OF THE INVENTION

1. Field of the Invention

The invention relates to an apparatus for generating electric power from wind energy.

2. Description of the Related Art

Referring to FIG. 1, a conventional apparatus for generating electric power from wind energy is shown to include a generator 5 fixed on a supporting surface 6, an upright rod 50 coupled to the generator 5 and serving as a shaft, and a blade unit mounted fixedly on the upright rod 50 and converting wind energy into a mechanical rotary power output. The blade unit includes a first blade member 51 and a second blade member 52. The first blade member 51 includes two vertically extending first blades arranged along and connected fixedly to the upright rod 50, and being S-shaped in cross section. The second blade member 52 includes three curved strip-shaped second blades that are angularly equidistant and that have upper ends connected to each other and connected fixedly to the upright rod 50, and lower ends opposite to the upper ends and connected to each other. Each second blade of the second blade member 52 cooperates with the upright rod 50 to constitute a D-shaped structure. The generator 5 converts the mechanical rotary power output into electric power.

However, since the conventional apparatus must be mounted fixedly on the supporting surface 6, displacement of the conventional apparatus is inconvenient.

### SUMMARY OF THE INVENTION

Therefore, the object of the present invention is to provide an apparatus for generating electric power from wind energy that is capable of displacement.

According to the present invention, there is provided an apparatus for generating electric power from wind energy. The apparatus comprises:

an upright structural frame having a base frame portion;

an upright rod extending vertically along a pivot axis that passes through a center of the structural frame, and having a lower end disposed in the base frame portion of the structural frame, and an upper end;

a blade unit mounted fixedly on the upright rod such that an assembly of the upright rod and the blade unit is rotatable relative to the structural frame about the pivot axis so as to convert wind energy into a mechanical rotary power output; and

a generator mounted on the base frame portion of the structural frame and coupled to the lower end of the blade unit to convert the mechanical rotary power output into electric power.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional apparatus for generating electric power from wind energy;

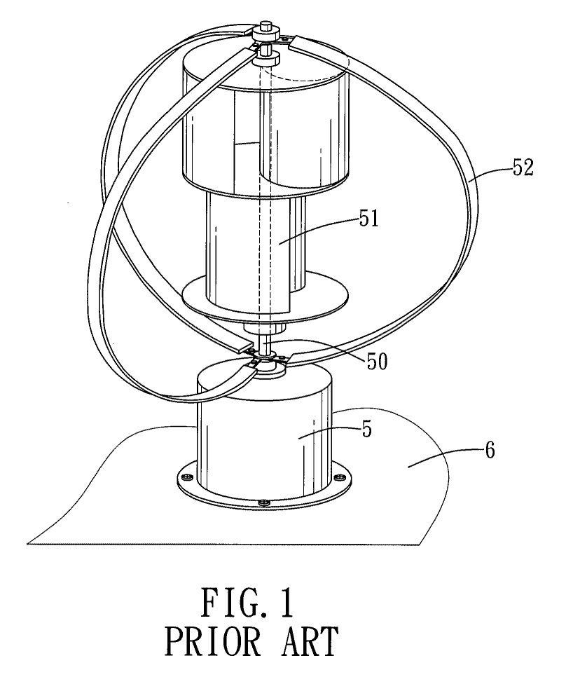

FIG. 2 is a perspective view showing the first preferred embodiment of an apparatus for generating electric power from wind energy according to the present invention;

FIG. 3 is a perspective view showing the second preferred embodiment of an apparatus for generating electric power from wind energy according to the present invention; and

FIG. 4 is a perspective view showing the third preferred embodiment of an apparatus for generating electric power from wind energy according to the present invention.

### DETAILED DESCRIPTION OF THE PREFERRED EMBODIMENTS

Before the present invention is described in greater detail, it should be noted that like elements are denoted by the same reference numerals throughout the disclosure.

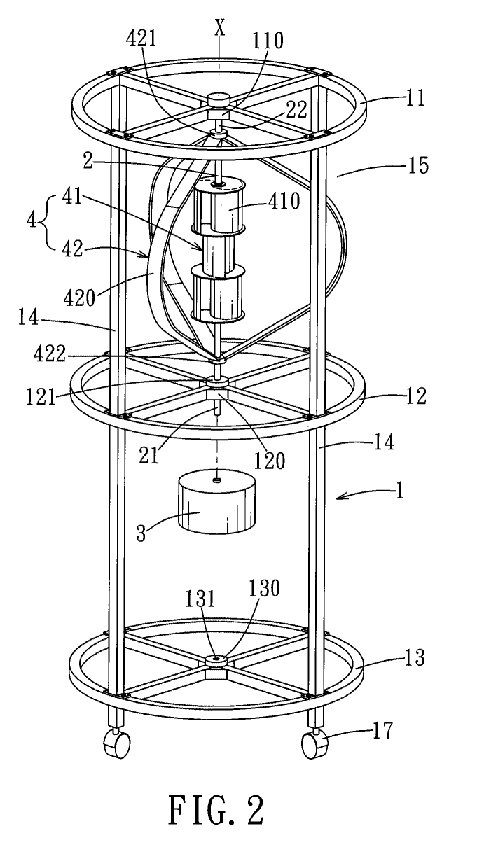

Referring to FIG. 2, the first preferred embodiment of an apparatus for generating electric power from wind energy according to the present invention is shown to include an upright structural frame 1, an upright rod 2, a blade unit 4, and a generator 3.

In this embodiment, the structural frame 1 includes three circular frame members 11, 12, 13, two adjacent ones of which are connected by a plurality of vertical supporting rods 14. Each of the circular frame members 11, 12, 13 has a central bearing seat 110, 120, 130. The circular frame member 11 cooperates with the circular frame member 12 to define a first accommodating space 15 therebetween. An assembly of the circular frame members 12, 13 and the supporting rods 14 serve as a base frame portion of the structural frame 1. A plurality of rolling wheels 17 are provided on a bottom side of the circular frame member 13.

The upright rod 2 extends vertically along a pivot axis (X) that passes through a center of the structural frame 1 (i.e., the bearing seats 110, 120, 130 of the circular frame members 11, 12, 13), and has a lower end 21 extending through an axial hole 121 in the bearing seat 120 of the circular frame member 12 and disposed in the base frame portion, and an upper end 22 coupled to the bearing seat 110 of the circular frame member 11.

The blade unit 4 is mounted fixedly on the upright rod 2 such that an assembly of the upright rod 2 and the blade unit 4 is rotatable relative to the structural frame 1 about the pivot axis (X) so as to convert wind energy into a mechanical rotary power output. In this embodiment, the blade unit 4 is disposed in the first accommodating space 15 in the structural frame 1, and includes a first blade member 41 connected fixedly to the upright rod 2, and a second blade member 42 connected fixedly to the upright rod 2 and disposed around the first blade member 41. The second blade member 42 has an upper portion 421 disposed above the first blade member 41, and a lower portion 422 disposed below the first blade member 41.

The first blade member 41 includes a plurality of vertically extending first blades 410 arranged along the pivot axis (X). Each first blade 410 is connected fixedly to the upright rod 2, and is S-shaped in cross section.

The second blade member 42 includes a plurality of curved strip-shaped second blades 420 that are angularly equidistant and that have upper ends connected to each other, connected fixedly to the upright rod 2 and constituting the upper portion 421 of the second blade member 42, and lower ends opposite to the upper ends, connected to each other, connected fixedly to the upright rod 2 and constituting the lower portion 422 of the second blade member 42. Each second blade 429 cooperates with the upright rod 2 to constitute a D-shaped structure.

The generator 3 is mounted on a bottom side of the circular frame member 12 of the structural frame 1, and is coupled to the lower end 21 of the upright rod 2 to convert the mechanical rotary power output into electric power. Since the feature of the invention does not reside in the configuration of the generator 3, which is conventional, details of the same are omitted herein for the sake of brevity.

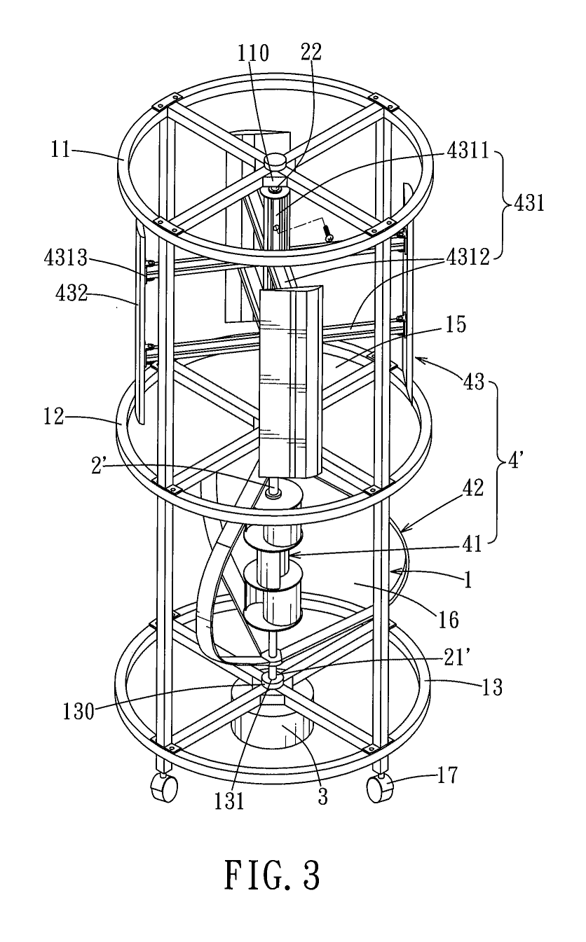

FIG. 3 illustrates the second preferred embodiment of an apparatus for generating electric power from wind energy according to this invention, which is a modification of the first preferred embodiment. In this embodiment, the structural frame 1 is further configured with a second accommodating space 16 between the circular frame members 12, 13.

The lower end 21′ of the upright rod 2 extends through an axial hole 131 in the bearing seat 130 of the circular frame member 13.

The first and second blade members 41, 42 are disposed in the second accommodating space 16 in the structural frame 1. The blade unit 4′ further includes a third blade member 43 disposed in the first accommodating space 15 in the structural frame 1 and connected fixedly to the upright rod 2′. The third blade member 43 includes a blade-mounting frame 431, and a plurality of upright third blades 432. The blade-mounting frame 431 has a central portion 4311 sleeved on and connected fixedly to the upright rod 2′, and a plurality of radial extensions 4312 extending radially from the central portion 4311. Each radial extension 4312 has a free end 4313. The upright third blades 432 are connected respectively and fixedly to the free ends 4313 of the radial extensions 4312 of the blade-mounting frame 431.

The generator 3 is disposed on the bottom side of the circular frame member 13.

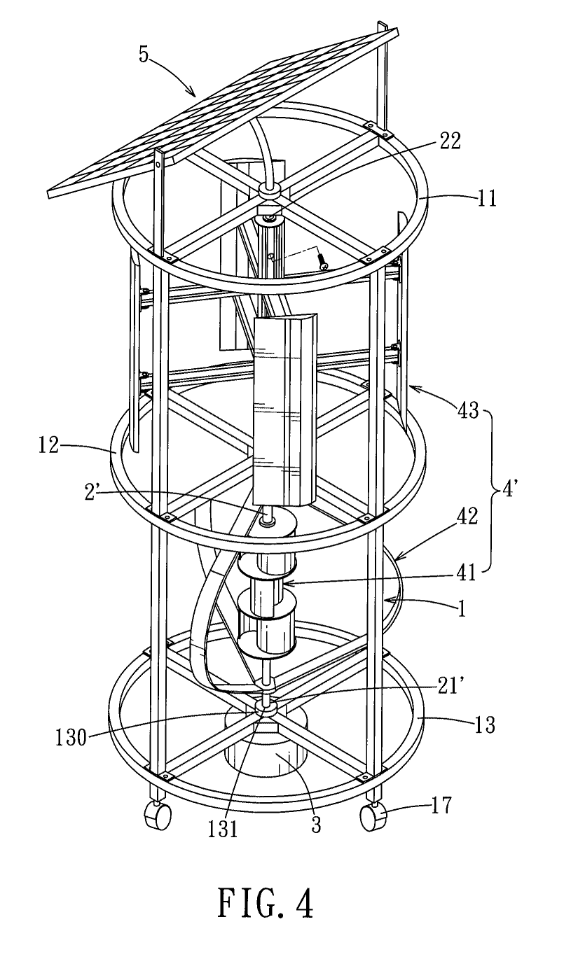

FIG. 4 illustrates the third preferred embodiment of an apparatus for generating electric power from wind energy according to this invention, which is a modification of the second preferred embodiment. In this embodiment, the apparatus further includes a solar cell unit 5 mounted on a top of the structural frame 1 for converting solar power into electrical energy.

In sum, due to the presence of the structural frame 1 provided with rolling wheels 17, the apparatus of the present invention can be easily displaced as required.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An apparatus for generating electric power from wind energy, comprising:
an upright structural frame having a base frame portion;
an upright rod extending vertically along a pivot axis that passes through a center of said structural frame, and having a lower end disposed in said base frame portion of said structural frame, and an upper end;
a blade unit mounted fixedly on said upright rod such that an assembly of said upright rod and said blade unit is rotatable relative to said structural frame about the pivot axis so as to convert wind energy into a mechanical rotary power output; and
a generator mounted on said base frame portion of said structural frame and coupled to said lower end of said blade unit to convert the mechanical rotary power output into electric power.

2. The apparatus as claimed in claim 1, wherein said blade unit includes:
a first blade member connected fixedly to said upright rod; and
a second blade member connected fixedly to said upright rod and disposed around said first blade member, said second blade member having an upper portion disposed above said first blade member, and a lower portion disposed below said first blade member.

3. The apparatus as claimed in claim 2, wherein:
said first blade member includes a plurality of vertically extending first blades arranged along the pivot axis, each of said first blades being connected fixedly to said upright rod, and being S-shaped in cross section; and
said second blade member includes a plurality of curved strip-shaped second blades that are angularly equidistant and that have upper ends connected to each other, connected fixedly to said upright rod and constituting said upper portion of said second blade member, and lower ends opposite to said upper ends, connected to each other, connected fixedly to said upright rod and constituting said lower portion of said second blade member, each of said second blades of said second blade member cooperating with said upright rod to constitute a D-shaped structure.

4. The apparatus as claimed in claim 3, wherein:
said structural frame is configured with two accommodating spaces, said first and second blade members being accommodated in one of said accommodating spaces; and
said blade unit further includes a third blade member accommodated in the other one of said accommodating spaces in said structural frame and connected fixedly to said upright rod.

5. The apparatus as claimed in claim 4, wherein said third blade member includes:
a blade-mounting frame having a central portion sleeved on and connected fixedly to said upright rod, and a plurality of radial extensions extending radially from said central portion, each of said radial extensions having a free end; and
a plurality of upright third blades connected respectively and fixedly to said free ends of said radial extensions of said blade-mounting frame.

6. The apparatus as claimed in claim 1, further comprising a solar cell unit mounted on a top of said structural frame for converting solar power into electrical energy.
